(19) United States
(12) Patent Application Publication
(10) Pub. No.: US 2025/0068880 A1
(43) Pub. Date: Feb. 27, 2025

(54) Systems and Methods for Improving Tag Locationing

(71) Applicant: ZEBRA TECHNOLOGIES CORPORATION, Lincolnshire, IL (US)

(72) Inventors: Patrick Martin Brown, North Medford, NY (US); Paul Selter, Port Jefferson Station, NY (US); Charles Burton Swope, Coral Springs, FL (US); Andrew R. Calvarese, Stony Brook, NY (US)

(21) Appl. No.: 18/237,261

(22) Filed: Aug. 23, 2023

(51) Int. Cl. G06K 19/077

(52) U.S. Cl. CPC G06K 19/07758; H04W 88/16

(57) ABSTRACT

Systems and methods for improving tag locationing are disclosed herein. An example system comprises: a plurality of tags configured to transmit data in response to requests; and a gateway that polls the plurality of tags at a first polling rate. The gateway may be configured to: receive a first request, in response to receiving the first request, transmit a signal to the plurality of tags that causes a first subset of the plurality of tags to transmit the data at a second polling rate that is different from the first polling rate, and receive the data from a second subset of the plurality of tags at the first polling rate.

### BACKGROUND

Digital technology is utilized in industrial networks for locationing services. More specifically, location data insight is a relevant component of entities seeking to track locations and statuses of their assets, enhance the productivity of their workers, and to generally optimize workflows. As such, development of devices that reliably provide cost-effective, proximity-based asset visibility solutions, and that are simultaneously convenient to deploy, simple to manage, and secure are a topic of great interest in the field of industrial networking.

However, conventional locationing devices suffer from several drawbacks that prevent them from providing such reliable, effective, and secure locationing services. Namely, many conventional locationing devices are inaccurate and frequently provide erroneous location reports for tags and their associated assets. Moreover, conventional locationing devices/systems do not employ collision avoidance, such that as the number of tags reporting increases, the time required to determine tag locations also increases. This relationship faced by conventional locationing devices/systems can create significant issues when a tag reporting high-priority information has that information delayed and/or lost due to waiting behind a lengthy queue of tag signals. Consequently, conventional locationing devices suffer from numerous issues that minimize the efficiency and effectiveness of the overall locationing system to locate individual tags and the corresponding assets.

Thus, there is a need for systems and methods for tag polling that allows for fast, efficient, secure, and reliable data transmission within a locationing system.

### SUMMARY

In an embodiment, the present invention is a system for improving tag locationing. The system may comprise: a plurality of tags configured to transmit data in response to requests; and a gateway that polls the plurality of tags at a first polling rate, the gateway being configured to: receive a first request, in response to receiving the first request, transmit a signal to the plurality of tags that causes a first subset of the plurality of tags to transmit the data at a second polling rate that is different from the first polling rate, and receive the data from a second subset of the plurality of tags at the first polling rate.

In a variation of this embodiment, each tag of the plurality of tags may be associated with an asset, and each asset associated with the second subset of the plurality of tags may be a high-priority asset.

In another variation of this embodiment, the gateway may be further configured to: receive the first request from a central server; generate the signal based on request data included in the first request; and transmit the signal to the plurality of tags using an integrated transmitter.

In yet another variation of this embodiment, the gateway may be a Bluetooth® Low Energy (BLE) gateway and each tag of the plurality of tags may be a BLE tag.

In still another variation of this embodiment, the BLE gateway may include a Radio Frequency Identification (RFID) transmitter, and each BLE tag of the plurality of tags may include an RFID receiver to receive the signal from the RFID transmitter.

In yet another variation of this embodiment, the second polling rate may be less than the first polling rate. Further in this variation, the second polling rate may be a zero-polling rate indicating that each tag of the first subset of the plurality of tags does not respond to the first request from the gateway.

In still another variation of this embodiment, the data from each tag may include a data payload with a priority bit sequence, and the gateway may be further configured to: transmit a second request to each of the plurality of tags; receive the data from each tag; analyze the data from each tag to determine priority bit values for each tag; and report the data from each tag in a priority sequence based on the priority bit values.

In another embodiment, the present invention is a computer-implemented method for improving tag locationing. The method may comprise: receiving, at a gateway receiving data from a plurality of tags at a first polling rate, a first request; responsive to receiving the first request, transmitting, by the gateway, a signal to the plurality of tags that causes a first subset of the plurality of tags to transmit the data at a second polling rate that is different from the first polling rate; and receiving, at the gateway, the data from a second subset of the plurality of tags at the first polling rate.

In a variation of this embodiment, each tag of the plurality of tags may be associated with an asset, and each asset associated with the second subset of the plurality of tags may be a high-priority asset.

In another variation of this embodiment, the computer-implemented method may further comprise: receiving, at the gateway, the first request from a central server; generating, by the gateway, the signal based on request data included in the first request; and transmitting, by the gateway using an integrated transmitter, the signal to the plurality of tags.

In yet another variation of this embodiment, the gateway may be a Bluetooth® Low Energy (BLE) gateway and each tag of the plurality of tags may be a BLE tag. Further in this variation, the BLE gateway may include a Radio Frequency Identification (RFID) transmitter, and each BLE tag of the plurality of tags may include an RFID receiver to receive the signal from the RFID transmitter.

In still another variation of this embodiment, the second polling rate may be less than the first polling rate.

In yet another variation of this embodiment, the second polling rate may be a zero-polling rate indicating that each tag of the first subset of the plurality of tags does not respond to the first request from the gateway.

In still another variation of this embodiment, the data from each tag may include a data payload with a priority bit sequence, and the computer-implemented method may further comprise: transmitting, by the gateway, a second request to each of the plurality of tags; receiving, at the gateway, the data from each tag; analyzing, by the gateway, the data from each tag to determine priority bit values for each tag; and reporting, by the gateway, the data from each tag in a priority sequence based on the priority bit values.

In yet another embodiment, the present invention is a tangible machine-readable medium comprising instructions for improving tag locationing that, when executed, cause a machine to at least: receive a first request associated with polling a plurality of tags that are transmitting data at a first polling rate; responsive to receiving the first request, transmit a signal to the plurality of tags that causes a first subset of the plurality of tags to transmit data at a second polling rate that is different from the first polling rate; and receive data from a second subset of the plurality of tags transmitting data at the first polling rate.

In a variation of this embodiment, each tag of the plurality of tags may be associated with an asset, and each asset associated with the second subset of the plurality of tags may be a high-priority asset.

In another variation of this embodiment, the second polling rate may be less than the first polling rate.

In yet another variation of this embodiment, the data from each tag may include a data payload with a priority bit sequence, and the instructions, when executed, may further cause the machine to at least: transmit a second request to each of the plurality of tags; receive the data from each tag; analyze the data from each tag to determine priority bit values for each tag; and report the data from each tag in a priority sequence based on the priority bit values.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example environment in which systems/devices for improving tag locationing may be implemented, in accordance with embodiments described herein.

FIG. 2A depicts a server transmitting a request to a gateway that causes the gateway to change the polling rate of proximate tags, in accordance with embodiments described herein.

FIG. 2B depicts a tag request and signal transmission process to adjust polling rates of tags associated with one or more groups, in accordance with embodiments described herein.

FIG. 2C depicts a priority bit value interpretation and message list adjustment process, in accordance with embodiments described herein.

FIG. 3 is a flowchart representative of a method for improving tag locationing, in accordance with embodiments described herein.

FIG. 4 is a block diagram of an example logic circuit for implementing example methods and/or operations described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As previously mentioned, conventional locationing systems suffer from a general lack of flexibility, such that accurate locationing of high-priority assets reporting with other lower priority assets may not be feasible. Many of these issues are the result of minimal (if any) collision avoidance and/or queue jumping for high-priority asset data packets. For example, a conventional high-priority tag may transfer/transmit data packets (also referenced herein as “tag polling”) at a first/base polling rate/frequency along with multiple (e.g., dozens, hundreds, thousands, etc.) other lower priority tags that may be assigned chronological reporting positions within a message list that is transmitted to a central server (also referenced herein as a “server”) for interpretation. In this example, the high-priority tag may be assigned a relatively low/late position within the message list queue (e.g., 1500^{th} position within the queue), resulting in the central server interpreting the high-priority message significantly later than is desired. This latency can lead to inaccurate locationing of the corresponding high-priority asset because the high-priority tag is unable to report messages to the central server as quickly and frequently as necessary/desired to confirm location estimates/predictions. Increasing the polling rate/frequency of such high-priority tags may increase the resulting number of reports transmitted to the central server but does not circumvent the message list queue/latency issues and decreases the battery life of the high-priority tag. Thus, in general, conventional locationing systems struggle to perform accurate locationing in a manner that accommodates multiple tags with different priority levels.

Thus, it is an objective of the present disclosure to eliminate these and other problems with conventional locationing systems via systems and methods that may selectively cause lower priority tags to transmit data packets at a lower polling rate and/or allow data packets from high-priority tags to jump to/near the front of a message list queue. In particular, the systems and methods of the present disclosure alleviate the issues present with conventional systems/devices by performing selective lower-rate/frequency data packet transmission and/or data packet bit modification/configuration to ensure that the location of high-priority assets are accurately determined. Of course, such decreased data packet polling rates/frequencies and/or data packet bit modification/configuration may be performed for any suitable reason. Regardless, selectively increasing and decreasing data packet polling rates/frequencies and/or modifying/configuring bits of tag data packets enables the systems and methods of the present disclosure to accurately determine the location of an asset at any given time while also accounting for asset priorities in a manner that was previously unachievable using conventional techniques.

As an example, the increasing/decreasing of data packet polling rates/frequencies may be or include radio frequency identification (RFID) transmissions from a gateway that cause the lower-priority tags to cease data packet transmission for a pre-determined period, thereby allowing the high-priority tags to transmit data packets to the gateway without interference from the lower-priority tags. Moreover, the data packets transmitted from the high-priority tags may include priority bit values that, when analyzed/interpreted by the gateway/central server, may cause the gateway/central server to move the high-priority tag data packets at/near the beginning of the message list queue (i.e., 1^{st} position) so that the high-priority data packets are analyzed before any lower priority tag data packets. Of course, it should be understood that the systems and methods described herein may achieve the prioritized reporting of high-priority tags by increasing high-priority tag data packet polling rates/frequencies, decreasing (e.g., to zero or non-zero values) low-priority tag data packet polling rates/frequencies, modifying/configuring bit values of the transmitted data packets (e.g., priority bit values), and/or any other suitable actions or combinations thereof.

Thus, in accordance with the above, and with the disclosure herein, the present disclosure includes improvements in computer functionality or in improvements to other technologies at least because the present disclosure describes that, e.g., locationing systems, and their related various components, may be improved or enhanced with the disclosed tag locationing systems and methods that provide more accurate, efficient, and appropriately prioritized locationing services for tags and corresponding assets. That is, the present disclosure describes improvements in the functioning of a locationing system itself or “any other technology or technical field” (e.g., the field of distributed/industrial locationing systems) because the disclosed tag locationing systems and methods improve and enhance operation of locationing systems by introducing improved selective data polling rates/frequencies and modified data packet bits to eliminate erroneous location determinations, delayed priority message transmission, and other inefficiencies typically experienced over time by locationing systems lacking such tag locationing systems and methods. This improves the state of the art at least because such previous locationing systems are inefficient and inaccurate as they lack the ability for selectively changing data polling rates/frequencies and/or data packet bits.

In addition, the present disclosure includes applying various features and functionality, as described herein, with, or by use of, a particular machine, e.g., a tag, a gateway, a server, and/or other hardware components as described herein.

Moreover, the present disclosure includes specific features other than what is well-understood, routine, conventional activity in the field, or adding unconventional steps that demonstrate, in various embodiments, particular useful applications, e.g., receiving, at a gateway initially receiving data from a plurality of tags at a first polling rate, a first request; responsive to receiving the first request, transmitting, by the gateway, a signal to the plurality of tags that causes a first subset of the plurality of tags to transmit the data at a second polling rate that is different from the first polling rate; and receiving, at the gateway, the data from a second subset of the plurality of tags at the first polling rate, among others.

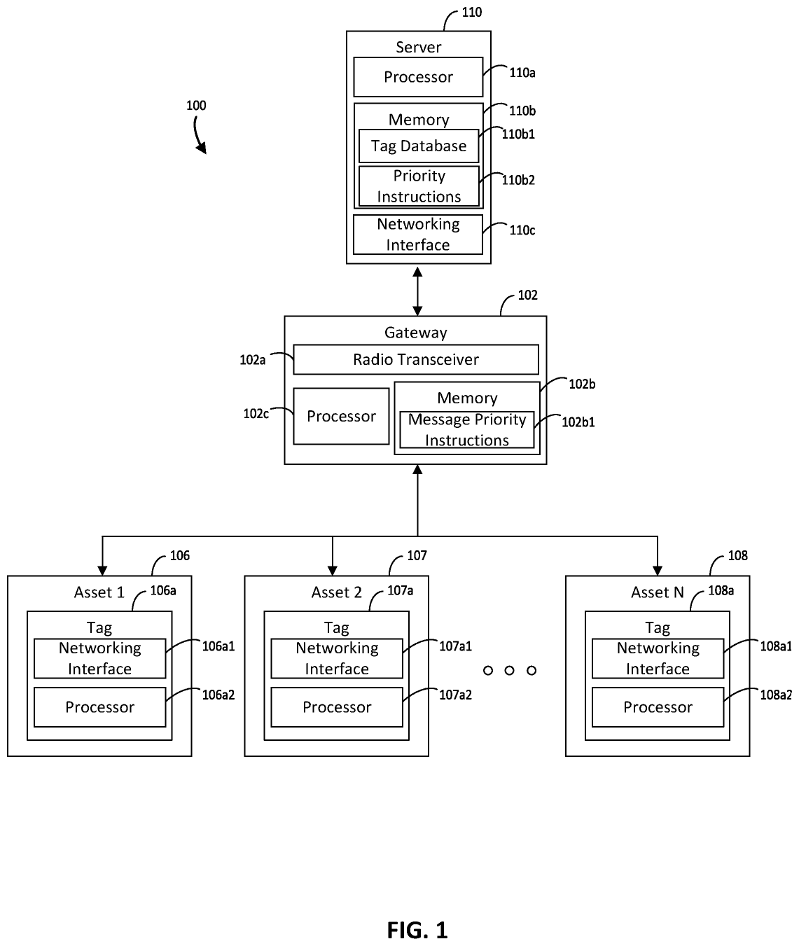

Turning to the figures, FIG. 1 depicts an example environment 100 in which systems/devices for improving tag locationing may be implemented, in accordance with embodiments described herein. The example environment 100 may comprise, include, and/or otherwise be a part of a networking environment in which the systems/devices of the present disclosure may operate. In the example embodiment of FIG. 1, the example environment 100 includes a gateway 102 that is communicatively coupled to a first tag 106a of a first asset 106, a second tag 107a of a second asset 107, a third tag 108a of an N^{th} asset 108, and a server 110. Generally speaking, the gateway 102, the first tag 106a, the second tag 107a, the third tag 108a, and/or the server 110 may be capable of executing instructions to, for example, implement operations of the example methods described herein, as may be represented by the flowcharts of the drawings that accompany this description. Namely, the gateway 102 may be connected to the first tag 106a, the second tag 107a, the third tag 108a, and/or the server 110 across multiple communication channels, and may generally be configured to receive and process information received from the first tag 106a, the second tag 107a, the third tag 108a, and/or the server 110.

The server 110 may store a tag database 110b1 and a set of priority instructions 110b2. The tag database 110b1 may be or include a listing of tags (e.g., tag 106a, tag 107a, tag 108a) that are proximate to specific gateways (e.g., gateway 102) and/or otherwise transmit data to the particular gateway(s). More specifically, the tag database 110b1 listings may include identification information about each of the tags 106a, 107a, 108a and/or the assets 106, 107, 108 associated with the tags 106a, 107a, 108a, as well as location information determined by the gateway 102. Of course, the tag database 110b1 may include any suitable information related to the tags and/or the assets associated with the tags.

To update the tag database 110b1, the server 110 may periodically request and/or otherwise receive updates from various gateways (e.g., gateway 102) disposed around an environment (e.g., example environment 100), and the server 110 may determine (via the one or more processors 110a) one or more tags indicated in the data received from the various gateways. The server 110 may then update the tag listing for each gateway by inputting each tag identified in the data received from the respective gateways into the corresponding tag listing of the tag database 110b1. For example, the tag database 110b1 may indicate at a first time that the gateway 102 received data from the first tag 106a and the second tag 107a. At a second time, the server 110 may transmit a request to the gateway 102 and/or may otherwise receive an update from the gateway 102 indicating that the gateway 102 received data from the first tag 106a, the second tag 107a, and the third tag 108a. Thus, the entries of the tag database 110b1 may indicate that the N^{th} asset 108 moved into a receptive proximity of the gateway 102 at some point between the first time and the second time, such that the gateway 102 was able to receive data transmitted from the third tag 108a at the second time.

The server 110 may also include a set of priority instructions 110b2, which may indicate priority levels/values for each tag 106a, 107a, 108a. These priority levels/values may generally define which tags 106a, 107a, 108a are higher and/or lower priority, and may be correspondingly impacted by requests to adjust data packet polling rates/frequencies of the tags 106a, 107a, 108a. Additionally, or alternatively, the set of priority instructions 110b2 may indicate only those tags which have a set of predefined priority instances. These priority instances may correspond to circumstances where the server 110 may receive less frequent data packet transmissions from lower priority tags and/or more frequent location updates for high-priority tags to more accurately track the high-priority tag/asset's location. Additionally, or alternatively, the priority instructions 110b2 may cause the server 110 to scan through received message lists from the gateway 102 to determine whether any messages in the list should be analyzed first and/or otherwise earlier than scheduled due to the presence of a priority bit value in the message.

For example, a first priority instance for a first high-priority tag may correspond to a period of time (e.g., scheduled operation/procedure of a patient) when the server 110 may cause proximate and/or otherwise nearby lower priority tags to transmit data packets at a lower/reduced polling rate relative to the first high-priority tag. In another example, a second priority instance for a second high-priority tag may correspond to one or more threshold values (e.g., location thresholds, movement thresholds, proximity thresholds) that, when exceeded/violated, may cause the server 110 to cause proximate lower priority tags to transmit data packets at a lower/reduced polling rate relative to the second high-priority tag.

As yet another example, the server 110 may receive a message list from the gateway 102 indicating received data packets from one-thousand tags (e.g., tag 108a of Asset N 108 is the one-thousandth tag reporting to the gateway 102). In this example, the message list may include a high-priority message from a high-priority tag at the nine-hundredth location, and the high-priority message may include/indicate a priority bit value. Upon receipt of the message list, the server 110 may scan through the entire list to determine whether any messages include such a priority bit value, and may identify the high-priority message at the nine-hundredth location and move the high-priority message to the first location. Of course, it should be understood that this example is for the purposes of discussion only, and such priority bit value detection and message reorganization may, for example, be performed by the gateway 102 prior to transmission of the message list to the server 110, as discussed herein.

Generally, each tag 106a, 107a, 108a may transmit data to the gateway 102 at a first polling rate. This first polling rate may be frequent enough to determine the approximate location of each corresponding asset 106, 107, 108 while not prioritizing any individual tags 106a, 107a, 108a. However, during a priority instance, the server 110 may transmit a request to the gateway 102 that is subsequently transmitted to the respective tags 106a, 107a, 108a, that causes a subset of the tags 106a, 107a, 108a to transmit data to the gateway 102 at a second polling rate that may be lower/decreased relative to the first polling rate. For example, the first polling rate may correspond to the tags transmitting data packets to the gateway 102 every second, millisecond, several seconds, etc., and the second polling rate may correspond to the tags transmitting data packets to the gateway 102 every several seconds, minutes, and/or ceasing to transmit data packets entirely for a predetermined period.

Such data packets may generally be or include identification information corresponding to the tags 106a, 107a, 108a and/or the associated assets 106, 107, 108, remaining battery life information, asset-specific data payloads, priority bit values, and/or any other suitable data or combinations thereof. Of course, it should be appreciated that the first polling rate may be higher/lower than the second polling rate. Moreover, in certain embodiments, data packets transmitted by any particular tag 106a, 107a, 108a during a priority instance and/or not during a priority instance may be or include a Bluetooth low energy (BLE) continuous tone extension (CTE) data packet.

As an exemplary priority instance, the first asset 106 may be a wristband attached to a hospital patient that is scheduled for a procedure at a first time. The priority instructions 110b2 may indicate this first time as a priority instance for the first tag 106a such that the other proximate, lower priority tags 107a, 108a should transmit data packets less frequently than the first tag 106a to ensure that the hospital patient's location may be tracked with a high degree of precision and accuracy without interference from the lower priority tags. Thus, when the server 110 determines that the first time has been reached, the server 110 may access the tag database 110b1 to determine which gateway(s) (e.g., gateway 102) are proximate to the first tag 106a and may transmit a request to any such proximate gateway(s) to cause the other proximate, lower priority tags 107a, 108a to transmit data packets at a decreased polling rate relative to the first tag 106a.

Namely, the server 110 may transmit the request at the first time to the gateway 102 and the gateway 102 may then subsequently transmit a signal to each of the first tag 106a, the second tag 107a, and the third tag 108a. The signal may include instructions and/or otherwise cause the first tag 106a to continue transmitting data packets to the gateway 102 at the first data polling rate/frequency and may cause the second tag 107a and the third tag 108a to adjust their data packet polling rates from the first polling rate to a second polling rate (e.g., zero data packet transmissions during the predetermined period). The second tag 107a and the third tag 108a may thereafter transmit data packets at the second polling rate until the tags 107a, 108a (and/or other suitable device(s)) determine that the predetermined period has elapsed and/or until the second tag 107a and the third tag 108a receive a subsequent signal including instructions to resume transmitting data packets at the first polling rate.

Continuing the prior example, and as mentioned, the priority instance corresponding to the hospital patient's procedure may have an associated predefined/predetermined period, during which, the second tag 107a and the third tag 108a may be instructed to transmit data packets to proximate gateways (e.g., gateway 102) at the second polling rate. This predefined period may begin at the first time, may end at a second time after the first time, and this predefined period may be stored as part of the priority instructions 110b2. In any event, the second tag 107a and the third tag 108a may begin transmitting data packets to the gateway 102 at the second polling rate at the first time in response to receiving the signal from the gateway 102. At the second time, the server 110 may determine that the predefined period corresponding to the priority instance of the first tag 106a has elapsed, and may transmit a second/subsequent request to a gateway (e.g., gateway 102) listed in the tag database 110b1 as having most recently received data packets from the second tag 107a and the third tag 108a. The gateway 102 may then transmit a subsequent signal to the second tag 107a and the third tag 108a indicating that the tags 107a, 108a should resume transmitting data packets to the gateway at the first polling rate. Additionally, or alternatively, the second tag 107a and the third tag 108a may independently track the predefined period, may independently determine at the second time that the predefined period has elapsed, and may independently adjust the data polling rate from the second polling rate to the first polling rate.

As part of these communications between the server 110 and the individual tags 106a, 107a, 108a, the gateway 102 may receive data from the server 110 and the tags 106a, 107a, 108a, and may transmit communications based on that received data to the server 110 and/or the tags 106a, 107a, 108a. Broadly speaking, the gateway 102 may be configured to transmit and receive data to/from the server 110 and nearby tags (e.g., the first tag 106a, the second tag 107a, the third tag 108a). In certain embodiments, the gateway 102 may be a hybrid Bluetooth® low energy (BLE) device that communicates with some/all of the devices in the environment 100 via BLE, and each tag 106a, 107a, 108a may be a BLE tag. In some embodiments, the gateway 102 may be a device that executes and/or conforms to any suitable software operating system (e.g., Android, iOS), a custom Internet of Things (IoT) bridge device with a BLE radio, and RFID transceiver/transmitter, and/or any other suitable device or combination thereof. Moreover, the signals generated and transmitted by the gateway 102 instructing tags 106a, 107a, 108a to switch from a first polling rate to a second polling rate may be or include RFID signals that are received and interpreted by RFID receiver circuits included as part of the tags 106a, 107a, 108a.

Namely, the gateway 102 may be configured to periodically listen for data packets from nearby tags (e.g., tags 106a, 107a, 108a), transmit the data packets and/or data obtained therein to the server 110, and/or broadcast requests received from the server 110 to such nearby tags. As an example, the gateway 102 may receive requests from the server 110, and may subsequently transmit signals to proximate tags 106a, 107a, 108a based on the requests. Such requests from the server 110 may be or include instructions causing the tags 106a, 107a, 108a to adjust the polling rate for data packets to the gateway 102, transmit identification data to the gateway, and/or other suitable instructions or combinations thereof.

The gateway 102 may also transmit and receive data (e.g., data packets) to/from any of the tags 106a, 107a, 108a to, for example, construct/organize a message list based on the data packets in accordance with the message priority instructions 102b1 stored in memory 102b, calculate an angle of arrival (AOA) for the tags 106a, 107a, 108a, and/or any other suitable actions or combinations thereof. The gateway 102 may then transmit the prioritized message list and/or any other data to the server 110 for tracking and/or otherwise notifying a user (e.g., locationing system administrator) of a location/position of an asset 106, 107, 108 associated with the tags 106a, 107a, 108a.

Generally, the message priority instructions 102b1 may be or include instructions enabling the processors 102c of the gateway 102 to construct a message list based on data packets received from the tags 106a, 107a, 108a. For example, the data packets transmitted from each tag 106a, 107a, 108a may include a data payload with a priority bit sequence, which may be comprised of one or more priority bit values. In this example, and as described herein, the message priority instructions 102b1 may enable the gateway 102 to transmit a signal to each of the tags 106a, 107a, 108a; receive the data packets from each tag 106a, 107a, 108a; analyze the data packets from each tag 106a, 107a, 108a to determine priority bit values for each tag; construct a prioritized message list that includes the tags 106a, 107a, 108a organized in a priority sequence based on the priority bit values; and report the prioritized message list to the server 110.

The gateway 102 may also include a radio transceiver 102a configured to transmit/receive data streams to/from various devices of the example environment 100, such as the server 110 and the tags 106a, 107a, 108a. The radio transceiver 102a may include an antenna with an associated gain profile corresponding to the transceiver's 102a antenna converting input power into radio waves (e.g., transmission) and/or received radio waves into electrical power (e.g., receiving).

The assets 106, 107, 108 may generally be any device, component, or object that an entity may desire to track and/or otherwise locate. For example, the assets 106, 107, 108 may be large and calibrated tools used in and/or for oil and gas equipment/operations, parcels for delivery by a shipping company, hospital equipment that is and/or may be moved to different floors/rooms, wristbands attached to hospital patients, and/or any other suitable objects or combinations thereof. While illustrated as three assets 106, 107, 108, it should be appreciated that the gateway 102 may simultaneously communicate with any suitable number of assets 106, 107, 108 via the associated tags 106a, 107a, 108a. Thus, the N^{th} asset 108 may be a third asset, a fifth asset, a twentieth asset, a one-hundredth asset, a ten-thousandth asset, and/or any other integer value asset.

Each asset 106, 107, 108 may also include a corresponding tag 106a, 107a, 108a that may be configured to transmit information associated with the asset 106, 107, 108 via the networking interface 106a1, 107a1, 108a1 to, for example, the gateway 102. Each asset tag 106a, 107a, 108a may also include one or more processors 106a2, 107a2, 108a2 configured to interpret and/or execute instructions contained in signal received from the gateway 102, server 110, and/or other suitable device(s). For example, the processors 106a2, 107a2, 108a2 may be configured to interpret signals received from the gateway 102 and thereby adjust the polling rate for data packets from a first polling rate to a second polling rate and/or from the second polling rate to the first polling rate.

Moreover, in certain embodiments, a workstation (not shown) may be communicatively connected to the server 110, and a user/operator may access the server 110 to retrieve a location associated with an asset 106, 107, 108. The workstation may query the server 110 with the identification tag of the corresponding asset 106, 107, 108, and the server 110 may match the identification tag with a location entry in the tag database 110b1 associated with the corresponding asset 106, 107, 108. The server 110 may then forward the location entry to the workstation for viewing by the user/operator.

More generally, the one or more memories 102b, 110b may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., priority instructions 110b2, message priority instructions 102b1, and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 102c, 110a (e.g., working in connection with a respective operating system in the one or more memories 102b, 110b) to facilitate, implement, or perform the machine readable instructions, methods, processes, elements or limitations, as illustrated, depicted, or described for the various flowcharts, illustrations, diagrams, figures, and/or other disclosure herein.

In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.). Moreover, the one or more memories 102b, 110b may also store machine readable instructions, including any of one or more application(s), one or more software component(s), and/or one or more APIs, which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein.

The one or more processors 102c, 110a may be connected to the one or more memories 102b, 110b via a computer bus (not shown) responsible for transmitting electronic data, data packets, or otherwise electronic signals to and from the one or more processors 102c, 110a and one or more memories 102b, 110b to implement or perform the machine readable instructions, methods, processes, elements or limitations, as illustrated, depicted, or described for the various flowcharts, illustrations, diagrams, figures, and/or other disclosure herein.

The one or more processors 102c, 110a may interface with the one or more memories 102b, 110b via the computer bus to execute any suitable application or executable instructions (e.g., priority instructions 110b2, message priority instructions 102b2) necessary to perform any of the actions associated with the methods of the present disclosure. The one or more processors 102c, 110a may also interface with the one or more memories 102b, 110b via the computer bus to create, read, update, delete, or otherwise access or interact with the data stored in the one or more memories 102b, 110b and/or external databases (e.g., a relational database, such as Oracle, DB2, MySQL, or a NoSQL based database, such as MongoDB). The data stored in the one or more memories 102b, 110b and/or an external database may include all or part of any of the data or information described herein, including, for example, asset tag 106a, 107a, 108a data packets, asset location data, AOA data, and/or other suitable information or combinations thereof.

The radio transceiver 102a and the networking interfaces 106a1, 107a1, 108a1 may be configured to communicate (e.g., send and receive) data via one or more external/network port(s) to one or more networks or local terminals, as described herein. In some embodiments, radio transceiver 102a and/or the networking interfaces 106a1, 107a1, 108a1 may include a client-server platform technology such as ASP.NET, Java J2EE, Ruby on Rails, Node.js, a web service or online API, responsive for receiving and responding to electronic requests. The radio transceiver 102a and/or the networking interfaces 106a1, 107a1, 108a1 may implement the client-server platform technology that may interact, via the computer bus, with the one or more memories 102b, 110b (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the radio transceiver 102a and the networking interfaces 106a1, 107a1, 108a1 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a network. In some embodiments, the network (not shown) may comprise a private network or local area network (LAN). Additionally, or alternatively, the network may comprise a public network such as the Internet. In some embodiments, the network may comprise routers, wireless switches, or other such wireless connection points communicating to gateway 102 (via the radio transceiver 102a), the first asset 106 (via networking interface 106a1), the second asset (via networking interface 107a1), the third asset (via networking interface 108a1), and/or the server 110 (via networking interface 110c) via wireless communications based on any one or more of various wireless standards, including by non-limiting example, a BLUETOOTH standard (e.g., BLE), IEEE 802.11a/b/c/g (WIFI), or the like.

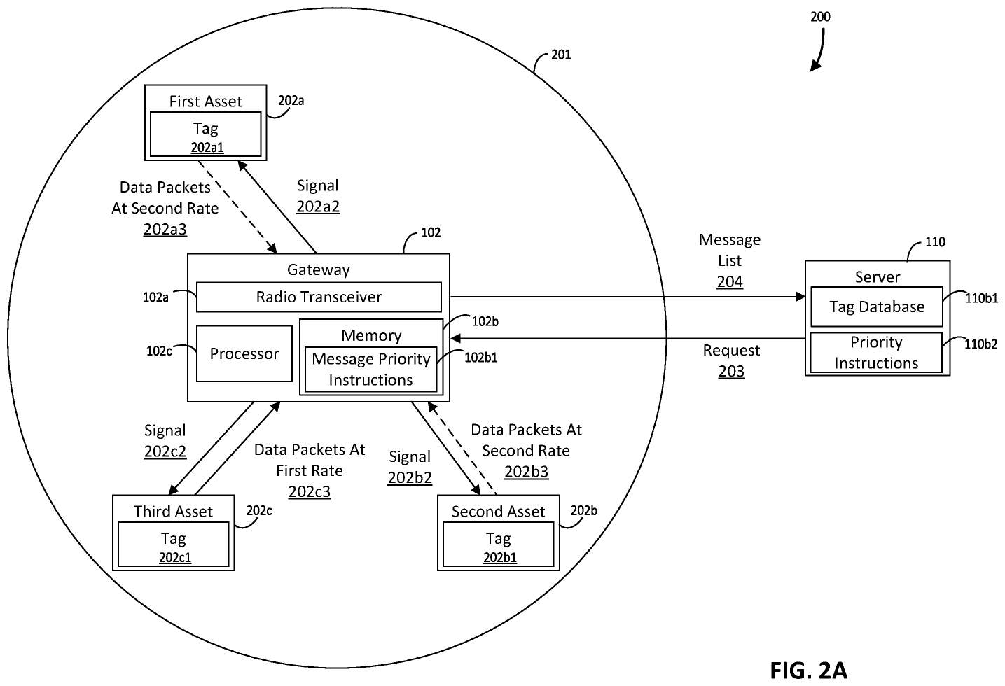

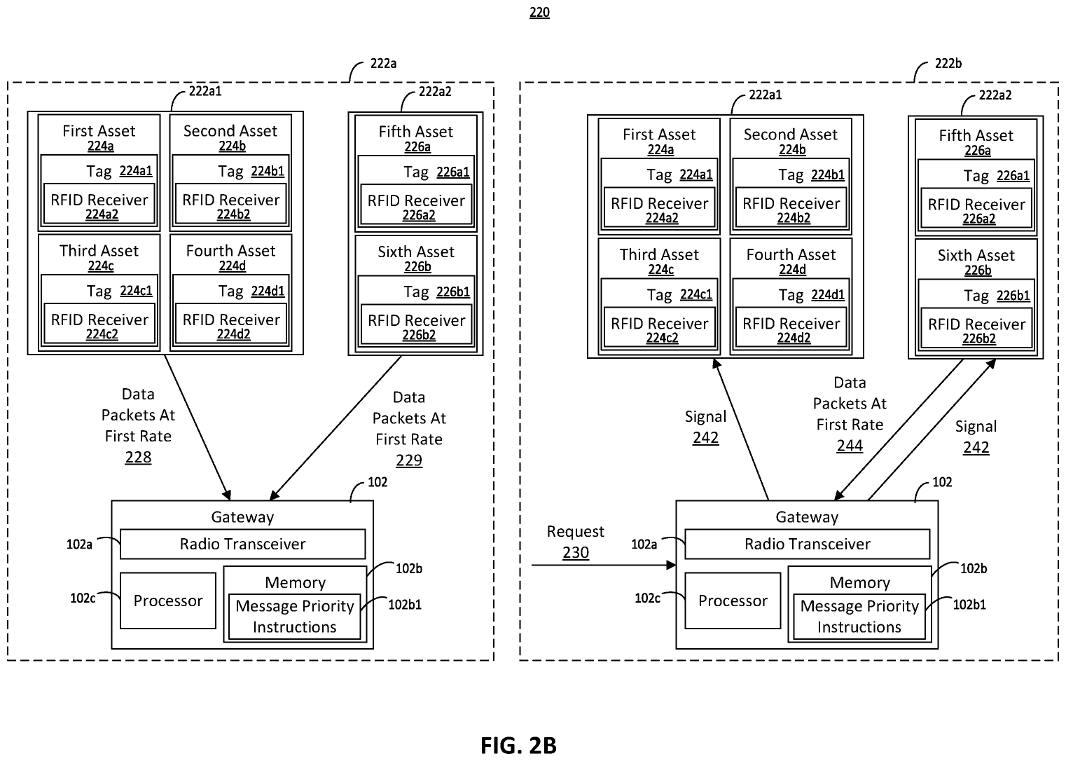

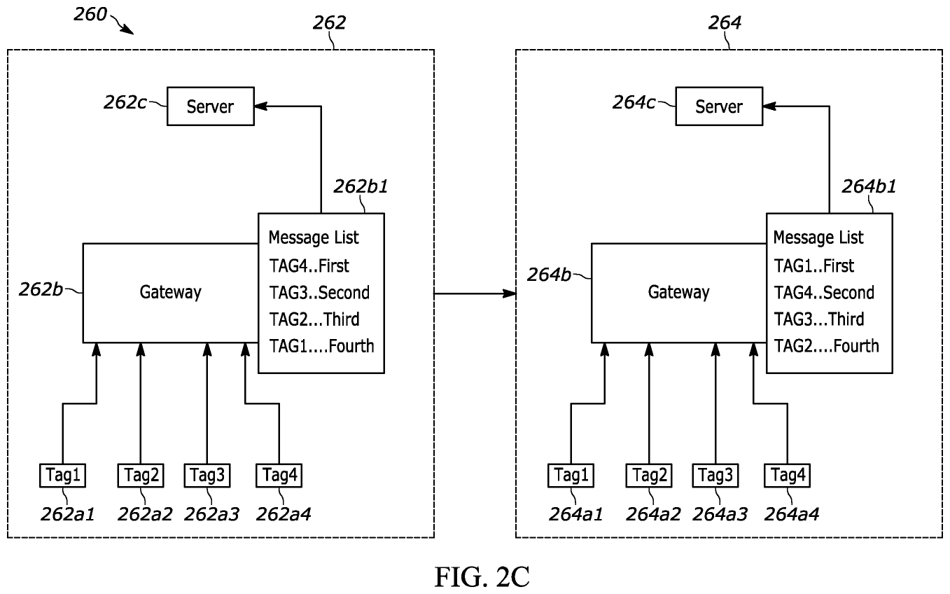

To illustrate a scenario where a server, gateway, and asset tag(s) may transmit and/or receive data packets at various polling rates based on priority instances, FIG. 2A depicts a server transmitting a request to a gateway that causes the gateway to change the polling rate of proximate tags, in accordance with embodiments described herein. In particular, the example scenario 200 illustrated in FIG. 2A depicts the server 110 transmitting a request 203 to the gateway 102, the gateway 102 transmitting signals 202a2, 202b2, 202c2 to each of the tags 202a1, 202b1, 202c1 associated with the proximate assets 202a, 202b, 202c, the tags 202a1, 202b1, 202c1 transmitting data packets to the gateway 102 at various polling rates, and the gateway 102 transmitting a message list 204 to the server 110. As referenced herein, the assets 202a, 202b, 202c may be “proximate assets” because each asset 202a, 202b, 202c is located within a transmission range 201 of the gateway 102. Thus, each proximate asset 202a, 202b, 202c (and the corresponding tags 202a1, 202b1, 202c1) may be physically close enough to the gateway 102 to receive and transmit signals (e.g., signals, data packets) to/from the gateway 102. Moreover, as referenced herein, the signals 202a2, 202b2, 202c2 transmitted by the gateway 102 to the proximate tags 202a1, 202b1, 202c1 may be or include polling requests configured to cause the proximate tags 202a1, 202b1, 202c1 to transmit data packets at a specified rate and/or to change the polling rate of such data packet transmissions.

In any event, as illustrated in FIG. 2A, the gateway 102 has three assets 202a, 202b, 202c within transmission range 201 of the gateway 102, such that the gateway 102 may transmit/receive data from the respective asset tags 202a1, 202b1, 202c1. In particular, the gateway 102 may receive a request 203 from the server 110, and the request 203 may be or include instructions that cause the gateway 102 to transmit signals 202a2, 202b2, 202c2 to the asset tags 202a1, 202b1, 202c1. The request 203 may more specifically include instructions that identify one or more of the asset tags 202a1, 202b1, 202c1 which should adjust their data packet polling rates, and the request 203 may also specify a number of data packets (i.e., samples) to be collected from any particular tag 202a1, 202b1, 202c1 as well as an adjusted (second) polling rate. Accordingly, the gateway 102 may transmit the signals 202a2, 202b2, 202c2 to the respective asset tags 202a1, 202b1, 202c1 based on the specific tags identified in the request 203 and/or may transmit signals 202a2, 202b2, 202c2 to all proximate asset tags 202a1, 202b1, 202c1. When the gateway 102 transmits signals 202a2, 202b2, 202c2 to all proximate assets tags 202a1, 202b1, 202c1, the proximate asset tags 202a1, 202b1, 202c1 may then independently analyze the signals 202a2, 202b2, 202c2 to determine whether each asset tag 202a1, 202b1, 202c1 should adjust the data packet polling rate.

For example, the request 203 transmitted from the server 110 may indicate that the third asset 202c tag 202c1 has a corresponding priority instance and that the tags 202a1, 202b1 should adjust the data packet polling rate from a first polling rate to a second polling rate. The gateway 102 may then transmit the signals 202a2, 202b2, 202c2 to the tags 202a1, 202b1, 202c1, wherein the tags 202a1 and 202b1 may adjust the polling rate of data packets transmitted to the gateway 102 from the first polling rate to the second polling rate 202a3, 202b3 for the duration of the priority instance. When the gateway 102 transmits the signal 202c2 to the third asset 202c tag 202c1, and the tag 202c1 may interpret the signal 202c2, determine that the signal 202c2 does not indicate the tag 202c1 should adjust the data packet polling rates, and may continue to transmit data packets to the gateway 102 at the first polling rate 202c3.

More specifically in the prior example, the gateway 102 may be located in a first hospital room, the first asset 202a may be a piece of medical equipment located in the first hospital room, the second asset 202b may be another piece of medical equipment assigned to the first hospital room, and the third asset 202c may be a wristband of a patient currently located in the first hospital room. The third asset 202c, and by association the third tag 202c1, may have a set of priority instructions 110b2 stored in the server 110 indicating that the third asset 202c may experience a priority instance at a first time corresponding to a beginning period of physical therapy for the patient in the first hospital room. Prior to the first time, each of the first asset 202a tag 202a1, the second asset 202b tag 202b1, and the third asset 202c tag 202c1 may periodically transmit data packets to the gateway 102 at the first polling rate. When the server 110 determines that the first time has arrived (i.e., begun), the server 110 may transmit the request 203 to the gateway 102, and the gateway 102 may transmit the signals 202a2, 202b2, 202c2 to the tags 202a1, 202b1, 202c1. The first and second tags 202a1, 202b1 may adjust the data packet polling rate from the first polling rate to the second polling rate (e.g., zero polling rate and/or a non-zero polling rate that is less than the first polling rate) and may subsequently begin transmitting data packets at the second polling rate 202a3, 202b3 while the patient receives physical therapy. Meanwhile, the tag 202c1 may continue transmitting data packets to the gateway 102 at the first polling rate 202c3.

When the scheduled period for physical therapy elapses and/or a user indicates that the patient's physical therapy has concluded, the first and second tags 202a1, 202b1 may resume transmitting data packets at the first polling rate. The server 110 may transmit a subsequent request indicating that the tags 202a1, 202b1 should re-adjust the data packet polling rate from the second polling rate to the first polling rate. Additionally, or alternatively, the tags 202a1, 202b1 may independently determine that the scheduled period corresponding to the priority instance has elapsed and may re-adjust the data packet polling rate from the second polling rate to the first polling rate.

Thus, as illustrated in the prior examples, the gateway 102 and the server 110 may receive data packets from the third asset 202c tag 202c1 at an increased polling rate relative to the data packets received from the first and second tags 202a1, 202b1 during the priority instance of the third asset 202c tag 202c1. The gateway 102 may determine a message list 204 using the received data packets from the third asset 202c tag 202c1 and/or the first and second tags 202a1, 202b1 based on the message priority instructions 102b1, and may then transmit the message list 204 to the server 110. During the priority instance corresponding to the third asset 202c, the gateway 102 may receive more and/or only data packets from the third asset 202c tag 202c1 transmitting data packets at the first polling rate and may thereby transmit message lists 204 during the period defining the priority instance that may include data packets or information derived therefrom corresponding only to the third asset 202c. Regardless, during the priority instance corresponding to the third asset 202c and/or at times other than such a priority instance, the message list 204 may include data packets and/or information derived therefrom corresponding to any combination of the proximate assets 202a, 202b, 202c.

Upon receipt of the message list 204, the server 110 may interpret and/or otherwise determine the location of the assets 202a, 202b, 202c indicated in the message list 204, analyze/interpret any additional data included in the message list 204 (e.g., associated with the high-priority tag(s)), and store such locations and/or information in the tag database 110b1. Thus, the server 110 may store more asset locations and/or other information in the tag database 110b1 for the particular asset experiencing the priority instance (e.g., third asset 202c) during the priority instance than the other assets (e.g., first asset 202a, second asset 202b) proximate to the gateway 102 during the priority instance. In this manner, the tag database 110b1 may precisely and accurately track the location of the particular asset during the priority instance by recording an increased number of asset locations for the duration of the priority instance. When the priority instance ends, the server 110, gateway 102, and/or the tags 202a1, 202b1, 202c1 may increase/decrease the data packet polling rate of any tags 202a1, 202b1, 202c1 that changed the polling rate to a lower/higher rate during the priority instance.

To provide a better understanding of the signal transmission and tag priority groupings discussed herein, FIG. 2B depicts a tag request and signal transmission process 220 to adjust polling rates of tags associated with one or more groups, in accordance with embodiments described herein. Broadly, the tag request and signal transmission process 220 illustrates how priority groupings of tags may be selectively signaled to adjust the data packet polling rates. This selective adjustment of the polling rates yields significantly reduced data packet traffic across the network, thereby allowing high priority tags an opportunity to transmit data packets without interference from lower priority tags and correspondingly communicate asset locations and asset information much faster and more accurately than conventional techniques.

As depicted in FIG. 2B, at a first time instance 222a, a low priority asset group 222a1 and a high priority asset group 222a2 transmit data packets to the gateway 102 at a first polling rate 228, 229. The low priority asset group 222a1 includes four assets 224a, 224b, 224c, 224d, each with a corresponding tag 224a1, 224b1, 224c1, 224d1. The high priority asset group 222a2 includes two assets 226a, 226b, each with a corresponding tag 226a1, 226b1. In the exemplary instance illustrated by the tag request and signal transmission process 220, the first polling rate 228, 229 may be one transmission per second, such that each of the tags 224a1, 224b1, 224c1, 224d1, 226a1, 226b1 transmits a data packet to the gateway every second.

However, at a second time instance 222b, the gateway 102 may receive a request 230 indicating, for example, that the tags 224a1, 224b1, 224c1, 224d1 from the low priority asset group 222a1 should be deactivated (or reduce polling rates) to reduce network traffic for the data packets transmitted by the tags 226a1, 226b1 of the high priority asset group 222a2. Namely, the second time instance 222b may represent the beginning of a priority instance for one or more of the high priority tags 226a1, 226b1, such that the request 230 causes the gateway 102 (and, by extension, the server) to prioritize data packets from the high priority asset group 222a2 by reducing the data packets transmitted from the low priority asset group 222a1.

The gateway 102 may interpret the request 230 and generate a signal (e.g., signal 242) configured to cause the tags 224a1, 224b1, 224c1, 224d1, 226a1, 226b1 to transmit data packets at a first polling rate or a second polling rate. For example, the signal 242 may include instructions that cause any tags (e.g., tags 224a1, 224b1, 224c1, 224d1) that do not include a priority bit value(s) in transmitted data packets to adjust the data packet polling rate from the first rate 228, 229 to a second polling rate. By contrast, any tags (e.g., tags 226a1, 226b1) including a priority bit value(s) in transmitted data packets may continue transmitting data packets at the first polling rate 244.

Thus, as illustrated in FIG. 2B, the gateway 102 may transmit a signal 242 to both the low priority asset group 222a1 and the high priority asset group 222a2. The tags 224a1, 224b1, 224c1, 224d1 in the low priority asset group 222a1 may receive the signal 242, determine that the data packet polling rate should be adjusted from the first polling rate 228 to a second polling rate, and may adjust the data packet polling rate from the first polling rate 228 to the second polling rate. In the example illustrated in FIG. 2B, the second polling rate may be a zero polling rate, such that the tags 224a1, 224b1, 224c1, 224d1 cease to transmit data packets beginning at the second time instance 222b. Of course, it should be noted that, in some examples, the second polling rate may be a non-zero polling rate that is less than the first polling rate.

As previously mentioned, the signal 242 may be or include an RFID signal configured to cause an RFID receiver circuit 224a2, 224b2, 224c2, 224d2, 226a2, 226b2 included as part of each tag 224a1, 224b1, 224c1, 224d1, 226a1, 226b1 to determine whether to deactivate data packet transmission and/or otherwise adjust (e.g., reduce) data packet polling rates during a predefined period (e.g., priority instance). Moreover, the gateway 102 may include an RFID transmitter (e.g., included as part of the radio transceiver 102a), and at the second time instance 222b, the gateway 102 may receive the request 230 and generate the signal 242 as an RFID signal 242 transmitted via the RFID transmitter 102a. Each tag 224a1, 224b1, 224c1, 224d1, 226a1, 226b1 may receive the signal from the gateway 102, and may utilize the RFID receiver circuit 224a2, 224b2, 224c2, 224d2, 226a2, 226b2 to interpret the RFID signal 242 and determine if and/or how to adjust the polling rate for transmitting data packets to the gateway 102.

In any event, the tags 226a1, 226b1 in the high priority asset group 222a2 may receive the signal 242, determine that the data packet polling rate should be maintained at the first polling rate 229, and may continue to transmit data packets at the first polling rate 244. Additionally, or alternatively, the signal 242 may cause the high priority asset group 222a2 to increase the polling rate from the first polling rate to a third polling rate that is higher than the first polling rate. Thus, in response to the signal 242, the low priority asset group 222a1 may decrease the polling frequency/rate and/or completely cease broadcasting data packets to the gateway 102, and the high priority asset group 222a2 may maintain and/or increase the polling frequency/rate of data packet broadcasting to the gateway 102.

In any event, these data packets transmitted by the high priority asset group 222a2 tags 226a1, 226b1 at the second time instance 222b may be received by the gateway 102, transmitted to a backend server (e.g., server 110), and interpreted by the server much more quickly than during the first time instance 222a due to the lack of competing data packets from the low priority asset group 222a1 tags 224a1, 224b1, 224c1, 224d1. Thus, beginning at the second time instance 222b, the high priority asset group 222a2 may be tracked more accurately than during the first time instance 222a because the low priority asset group 222a1 tags 224a1, 224b1, 224c1, 224d1 have ceased to transmit data packets (or are doing so at a significantly reduced polling rate).

In addition to the systems and methods of the present disclosure causing proximate tags to adjust data packet polling rates, the systems and methods of the present disclosure may also create, organize, and interpret message lists containing data packets and/or information derived therefrom to improve tag locationing. FIG. 2C depicts a priority bit value interpretation and message list adjustment process 260, in accordance with embodiments described herein. Generally, the priority bit value interpretation and message list adjustment process 260 includes a first message list instance 262 and a second message list instance 264.

At the first message list instance 262, a set of tags 262a1, 262a2, 262a3, 262a4 may each transmit data packets to a gateway 262b, and the gateway 262b may generate a message list 262b1. In certain embodiments, the gateway 262b may generate the message list 262b1 in chronological order, such that data packets are listed in the message list 262b1 corresponding to the order in which the data packets arrived at the gateway 262b.

In particular, the set of tags 262a1, 262a2, 262a3, 262a4 may transmit data in a sequence where the fourth tag 262a4 transmits data packets that arrive at the gateway 262b first, the third tag 262a3 transmits data packets that arrive at the gateway 262b second, the second tag 262a2 transmits data packets that arrive at the gateway 262b third, and the first tag 262a1 transmits data packets that arrive at the gateway 262b fourth. Accordingly, the message list 262b1 may indicate the received data packets (or information derived therefrom) in chronological order, such that the message list 262b1 includes the fourth tag 262a4 data packets first, the third tag 262a3 data packets second, the second tag 262a2 data packets third, and the first tag 262a1 data packets fourth.

When the gateway 262b generates the message list 262b1, the gateway 262b may transmit the message list 262b1 to the server 262c for analysis. The server 262c may receive the message list 262b1 and analyze the data contained therein in the original order provided by the gateway 262b. Thus, the server 262c receiving the message list 262b1 may analyze the fourth tag 262a4 data packets first, the third tag 262a3 data packets second, the second tag 262a2 data packets third, and the first tag 262a1 data packets fourth. However, such chronological listing and interpretation of the data packets can result in the latency and accuracy issues previously described. For example, if the first tag 262a1 is a high priority tag, then the data packets transmitted by the first tag 262a1 may not be analyzed and/or otherwise interpreted until the data packets associated with the other tags 262a2-4 are analyzed/interpreted.

To avoid such issues, the second message list instance 264 illustrates an alternative message list generation procedure that leverages priority bit values of high priority assets/tags. More specifically, when the gateway 264b generates the message list 264b1, the gateway 264b may place data packets and/or other information containing such priority bit value(s) at/near the beginning of the message list 264b1 to ensure that the server 264c analyzes/interprets such data packets quickly.

As an example, the first tag 264a1 may be a high priority tag associated with a high priority asset, and the other tags 264a2, 264a3, 264a4 may be lower priority tags associated with lower priority assets. The data packets from each of the second tag 264a2, the third tag 264a3, and the fourth tag 264a4 may arrive at the gateway 264b prior to the data packet from the first tag 264a1. The first tag 264a1 may include a priority bit value as part of the data payload and/or other portion(s) of the data packets transmitted to the gateway 264b, and each of the data packets from the other tags 264a2, 264a3, 264a4 may lack such a priority bit value. The gateway 264b may analyze a portion of the received data packets to determine whether any data packets include a priority bit value. In this example, the gateway 264b may determine that the data packet from the first tag 264a1 includes a priority bit value and may place the data packet from the first tag 264a1 at the beginning of the message list 264b1, despite the first tag 264a1 data packet arriving at the gateway 264b after the data packets from the other tags 264a2, 264a3, 264a4.

In this manner, the server 264c in the second message list instance 264 may analyze/interpret the data packet from the high priority tag (e.g., first tag 262a1, 264a1) sooner than the server 262c the first message list instance 262. The server 264c may receive the message list 264b1 and may immediately interpret/analyze the data packet from the high priority tag 264a1 because the data packet (or information derived therefrom) is listed first in the message list 264b1. Thus, the server 264c may quickly analyze the high priority data from the first tag 264a1 and perform any necessary actions thereafter significantly faster than the server 262c in the first message list instance 264. This process of elevating high priority data packets/information within generated message lists increases the response time of locationing system components (e.g., server 110) to such high priority data, and thereby improves the ability of the locationing system to effectively track and respond to location changes and/or other information indicated in the data packets corresponding to high priority assets relative to conventional techniques.

It should be appreciated that the high priority data elevation process illustrated by the second message list instance 264 may be performed for any suitable number of high priority assets/tags. For example, the first and second tags 264a1, 264a2 may be high priority tags associated with high priority assets, and the third and fourth tags 264a3, 264a4 may be lower priority tags associated with lower priority assets. The tags 264a1, 264a2, 264a3, 264a4 may transmit data packets to the gateway 264b such that the data packets from the third tag 264a3 arrive first, the data packets from the fourth tag 264a4 arrive second, the data packets from the second tag 264a2 arrive third, and the data packets from the first tag 264a1 arrive fourth. In this example, the gateway 264b may analyze the data packets for priority bit values and generate a message list that includes the data packets from the second tag 264a2 first, the first tag 264a1 second, the third tag 264a3 third, and the fourth tag 264a4 fourth. Thus, the gateway 264b (e.g., executing instructions included as part of the message priority instructions 102b1) may generate the message list by placing high priority data packets first in the order in which they arrived at the gateway 264b, and then proceed to include the lower priority data packets in the order in which they arrived. However, it should be appreciated that any suitable ordering strategy/rules may be employed.

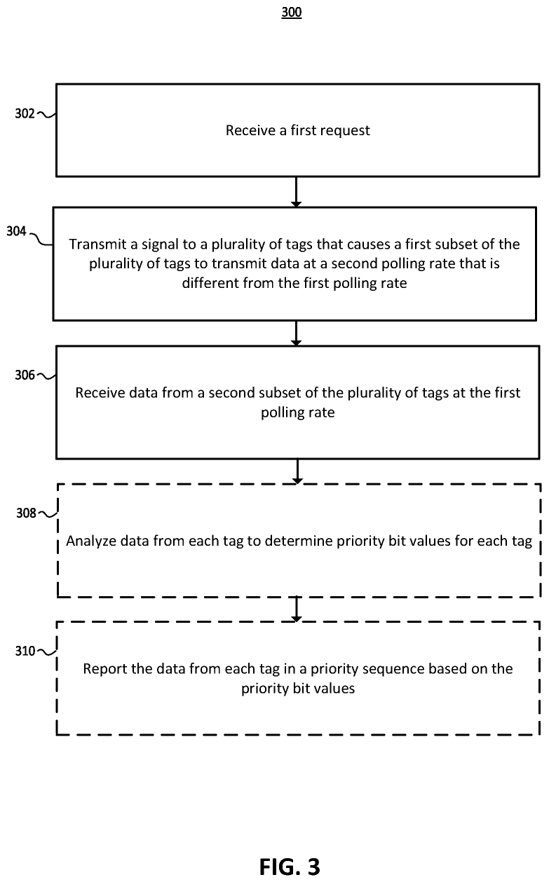

FIG. 3 is a flowchart representative of a method 300 for improving tag locationing, in accordance with embodiments described herein. Generally, the method 300 enables the server 110, the gateway 102, and the tags (e.g., tags 106a, 107a, 108a) to enhance/improve the speed, efficiency, and reliability of asset locationing/tracking by selectively decreasing/increasing the data packet polling rates and/or reporting message list ordering for data packets of high-priority tags or proximate non-priority tags, as described herein. It is to be understood that any of the steps of the method 300 may be performed by, for example, the server 110, the gateway 102, tags (e.g., tags 106a, 107a, 108a), and/or any other suitable components or combinations thereof discussed herein.

At block 302, the method 300 includes receiving, at a gateway initially receiving data from a plurality of tags at a first polling rate, a first request. The method 300 may further include, responsive to receiving the first request, transmitting, by the gateway, a signal to the plurality of tags that causes a first subset of the plurality of tags to transmit the data at a second polling rate that is different from the first polling rate (block 304). The method 300 may further include receiving, at the gateway, the data from a second subset of the plurality of tags at the first polling rate (block 306).

In certain embodiments, the method 300 may further include analyzing, by the gateway, the data from each tag to determine priority bit values for each tag (block 308). Further in these embodiments, the method 300 may include reporting, by the gateway, the data from each tag in a priority sequence based on the priority bit values (block 310). Moreover, in these embodiments, the data from each tag may include a data payload with a priority bit sequence, and the method 300 may further include transmitting, by the gateway, a second request to each of the plurality of tags; and receiving, at the gateway, the data from each tag.

In some embodiments, each tag of the plurality of tags may be associated with an asset, and each asset associated with the second subset of the plurality of tags may be a high-priority asset.

In certain embodiments, the method 300 may further include: receiving, at the gateway, the first request from a central server; generating, by the gateway, the signal based on request data included in the first request; and transmitting, by the gateway using an integrated transmitter, the signal to the plurality of tags.

In some embodiments, the gateway may be a Bluetooth® Low Energy (BLE) gateway and each tag of the plurality of tags may be a BLE tag. Further in these embodiments, the BLE gateway may include a Radio Frequency Identification (RFID) transmitter, and each BLE tag of the plurality of tags may include an RFID receiver to receive the signal from the RFID transmitter.

In certain embodiments, the second polling rate may be less than the first polling rate. Further, in some embodiments, the second polling rate may be a zero-polling rate indicating that each tag of the first subset does not respond to the first request from the gateway.

Of course, it is to be appreciated that the actions of the method 300 may be performed in any suitable order and any suitable number of times.

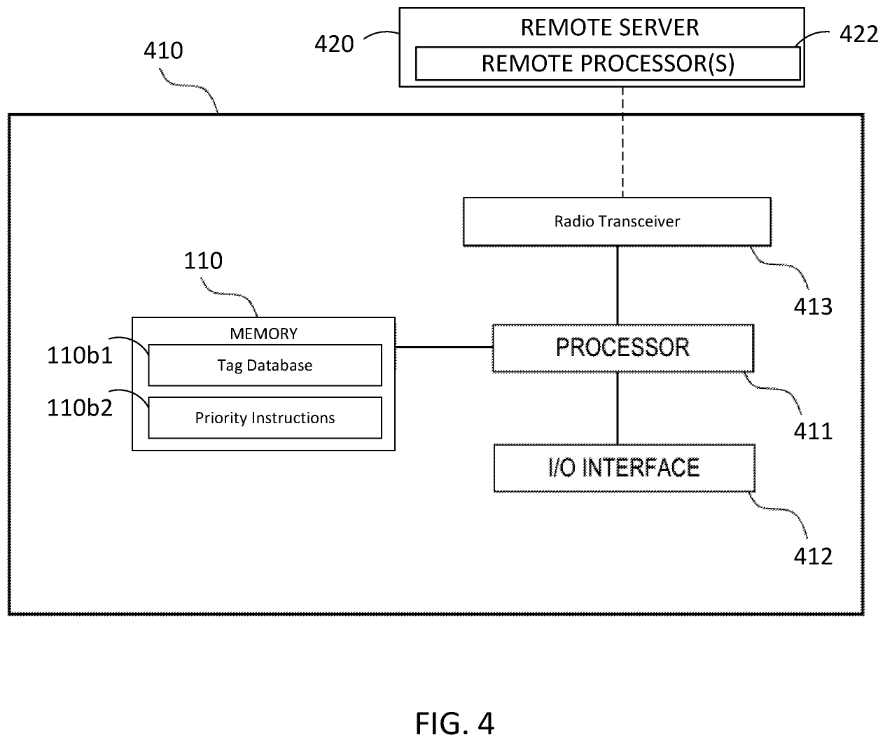

FIG. 4 is a block diagram representative of an example logic circuit capable of implementing example methods and/or operations described herein. As an example, the example logic circuit may be capable of implementing one or more components of the server 110 of FIG. 1. Of course, it should be understood that the example logic circuit may also include and/or otherwise access instructions and/or components of other components represented in FIG. 1 and/or elsewhere herein, such as the gateway 102, tags (e.g., tags 106a, 107a, 108a) and the like.

The example logic circuit of FIG. 4 is a processing platform 410 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 410 of FIG. 4 includes a processor 411 such as, for example, one or more microprocessors, controllers, and/or any suitable type of processor. The example processing platform 410 of FIG. 4 includes memory (e.g., volatile memory, non-volatile memory) 110 accessible by the processor 411 (e.g., via a memory controller). The example processor 411 interacts with the memory 110 to obtain, for example, machine-readable instructions stored in the memory 110 corresponding to, for example, the operations represented by the flowcharts of this disclosure. The memory 110 also includes the tag database 110b1 and the priority instructions 110b2 that are accessible by the example processor 411.

The priority instructions 110b2 may comprise rule-based instructions configured to, for example, cause the example processor 411 to determine when particular asset tag(s) ought to be prioritized while reporting by decreasing other non-priority tag data packet polling rates, increasing the priority tag(s) data packet polling rates, automatically positioning data packets from priority tags at/near a beginning of a report message list, and/or any other suitable actions or combinations thereof. The priority instructions 110b2 may further comprise rule-based instructions configured to, for example, cause the example processor 411 to construct requests (e.g., request 203, 230) configured to cause the asset tags to adjust data packet polling rates in accordance with the conditions specified in the priority instructions 110b2.

To illustrate, the example processor 411 may access the memory 110 to execute, reference, and/or otherwise interpret the tag database 110b1 and/or the priority instructions 110b2 to determine that a first tag is experiencing a priority instance and/or otherwise has high-priority data packets. In response, the example processor 411 may execute the priority instructions 110b2 to construct a request for transmission to a gateway (e.g., gateway 102) proximate to the first tag that causes non-priority tags reporting to the gateway to decrease their data packet polling rates, the first tag to increase its data packet polling rate, and/or automatically positioning data packets from the first tag at/near a beginning of a report message list. Additionally, or alternatively, machine-readable instructions corresponding to the example operations described herein may be stored on one or more removable media (e.g., a compact disc, a digital versatile disc, removable flash memory, etc.) that may be coupled to the processing platform 410 to provide access to the machine-readable instructions stored thereon.

The example processing platform 410 of FIG. 4 also includes a radio transceiver 413 to enable communication with other machines via, for example, one or more networks. The example radio transceiver 413 includes any suitable type of communication interface(s) (e.g., wired and/or wireless interfaces) configured to operate in accordance with any suitable protocol(s) (e.g., Ethernet for wired communications, and/or BLE or IEEE 802.11 for wireless communications).

The example processing platform 410 of FIG. 4 also includes input/output (I/O) interfaces 412 to enable receipt of user input and communication of output data to the user. Such user input and communication may include, for example, any number of keyboards, mice, USB drives, optical drives, screens, touchscreens, etc.

Further, the example processing platform 410 may be connected to a remote server 420. The remote server 420 may include one or more remote processors 422, and may be configured to execute instructions to, for example, implement operations of the example methods described herein, as may be represented by the flowcharts of the drawings that accompany this description.

### Additional Considerations

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

The claims are:

1. A system for improving tag locationing, the system comprising:
a plurality of tags configured to transmit data in response to requests; and
a gateway that polls the plurality of tags at a first polling rate, the gateway being configured to:
receive a first request,
in response to receiving the first request, transmit a signal to the plurality of tags that causes a first subset of the plurality of tags to transmit the data at a second polling rate that is different from the first polling rate, and
receive the data from a second subset of the plurality of tags at the first polling rate.

2. The system of claim 1, wherein each tag of the plurality of tags is associated with an asset, and each asset associated with the second subset of the plurality of tags is a high-priority asset.

3. The system of claim 1, wherein the gateway is further configured to:
receive the first request from a central server;
generate the signal based on request data included in the first request; and
transmit the signal to the plurality of tags using an integrated transmitter.

4. The system of claim 1, wherein the gateway is a Bluetooth® Low Energy (BLE) gateway and each tag of the plurality of tags is a BLE tag.

5. The system of claim 5, wherein the BLE gateway includes a Radio Frequency Identification (RFID) transmitter, and each BLE tag of the plurality of tags includes an RFID receiver to receive the signal from the RFID transmitter.

6. The system of claim 1, wherein the second polling rate is less than the first polling rate.

7. The system of claim 6, wherein the second polling rate is a zero-polling rate indicating that each tag of the first subset of the plurality of tags does not respond to the first request from the gateway.

8. The system of claim 1, wherein the data from each tag includes a data payload with a priority bit sequence, and the gateway is further configured to:
transmit a second request to each of the plurality of tags;
receive the data from each tag;
analyze the data from each tag to determine priority bit values for each tag; and
report the data from each tag in a priority sequence based on the priority bit values.

9. A computer-implemented method for improving tag locationing, the method comprising:
receiving, at a gateway receiving data from a plurality of tags at a first polling rate, a first request;
responsive to receiving the first request, transmitting, by the gateway, a signal to the plurality of tags that causes a first subset of the plurality of tags to transmit the data at a second polling rate that is different from the first polling rate; and
receiving, at the gateway, the data from a second subset of the plurality of tags at the first polling rate.

10. The computer-implemented method of claim 9, wherein each tag of the plurality of tags is associated with an asset, and each asset associated with the second subset of the plurality of tags is a high-priority asset.

11. The computer-implemented method of claim 9, further comprising:
receiving, at the gateway, the first request from a central server;
generating, by the gateway, the signal based on request data included in the first request; and
transmitting, by the gateway using an integrated transmitter, the signal to the plurality of tags.

12. The computer-implemented method of claim 9, wherein the gateway is a Bluetooth® Low Energy (BLE) gateway and each tag of the plurality of tags is a BLE tag.

13. The computer-implemented method of claim 12, wherein the BLE gateway includes a Radio Frequency Identification (RFID) transmitter, and each BLE tag of the plurality of tags includes an RFID receiver to receive the signal from the RFID transmitter.

14. The computer-implemented method of claim 9, wherein the second polling rate is less than the first polling rate.

15. The computer-implemented method of claim 14, wherein the second polling rate is a zero-polling rate indicating that each tag of the first subset of the plurality of tags does not respond to the first request from the gateway.

16. The computer-implemented method of claim 9, wherein the data from each tag includes a data payload with a priority bit sequence, and the computer-implemented method further comprises:
transmitting, by the gateway, a second request to each of the plurality of tags;
receiving, at the gateway, the data from each tag;
analyzing, by the gateway, the data from each tag to determine priority bit values for each tag; and
reporting, by the gateway, the data from each tag in a priority sequence based on the priority bit values.

17. A tangible machine-readable medium comprising instructions for improving tag locationing that, when executed, cause a machine to at least:
receive a first request associated with polling a plurality of tags that are transmitting data at a first polling rate;
responsive to receiving the first request, transmit a signal to the plurality of tags that causes a first subset of the plurality of tags to transmit data at a second polling rate that is different from the first polling rate; and
receive data from a second subset of the plurality of tags transmitting data at the first polling rate.

18. The tangible machine-readable medium of claim 17, wherein each tag of the plurality of tags is associated with an asset, and each asset associated with the second subset of the plurality of tags is a high-priority asset.

19. The tangible machine-readable medium of claim 17, wherein the second polling rate is less than the first polling rate.

20. The tangible machine-readable medium of claim 17, wherein the data from each tag includes a data payload with a priority bit sequence, and the instructions, when executed, further cause the machine to at least:
transmit a second request to each of the plurality of tags;
receive the data from each tag;
analyze the data from each tag to determine priority bit values for each tag; and
report the data from each tag in a priority sequence based on the priority bit values.
